(19) United States
(12) Patent Application Publication
(10) Pub. No.: US 2002/0184263 A1
(43) Pub. Date: Dec. 5, 2002

(54) Method and system for converting usage data to extensive markup language

(76) Inventors: Pierre Perinet, Fort Collins, CO (US); Eric Peterson, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/860,060

(22) Filed: May 17, 2001

(51) Int. Cl. G06F 17/21

(52) U.S. Cl. 707/513; 707/505

(57) ABSTRACT

A method for converting usage data into Extensive Markup Language, wherein the usage data includes a plurality of categories having at least one parameter assigned to each category. The method includes the steps of generating all possible combinations including a parameter from each category, defining an identifier tag for uniquely identifying each generated combination, defining a table tag for representing an associated data of each identifier tag, and saving all tags to an Extensive Markup Language file.

The present invention generally relates to an improved method and system for converting usage data into Extensive Markup Language. More specifically, it relates to an improved method and system for converting usage data into an Extensive Markup Language, wherein the usage data includes a plurality of categories having at least one parameter assigned to each category.

### BACKGROUND OF THE INVENTIVE ART

Because Internet servers can provide valuable information about their users, currently many software applications are designed to collect such usage data. The data includes important information relating to items, such as usage measure, geographical information, and user service requests. For example, the data can provide valuable information for a business manager in trying to understand the usage behavior of users, identify needs for new services, managing the pricing of subscription plans and determine profit margin. All this information can provide managers with valuable marketing tools. Software applications for collecting usage data are generally known as Internet Usage Managers (“IUM”).

An IUM typically includes a data collector for saving any user data relating to the server. Because the Internet provides a more flexible and universal platform, the usage data should be in Standard Generalized Markup Language (“SGML”) for use with a web browser. More specifically, the preferred SGML is Extensive Markup Language (“XML”). Since the data collector is set up to collect data continuously, it is difficult to generate such SGML files in this continuous setting.

The present invention may be used with another invention disclosed in a commonly owned U.S. Patent application [Attorney Docket PDNO 10012502-1] filed on May 10, 2001 entitled “Method And System For Archiving Data Within A Predetermined Time Interval” bearing Serial No. ______ by Pierre Perinet and Eric Peterson, assigned to the Hewlett-Packard (“HP”) company. This patent application is specifically incorporated by reference herein.

### BRIEF SUMMARY OF THE INVENTION

The present invention is directed to an improved method and system for converting usage data into Extensive Markup Language. More specifically, it relates to an improved method and system for converting usage data into Extensive Markup Language, wherein the usage data includes a plurality of categories having at least one parameter assigned to each category.

The present invention provides a method that includes the steps of generating all possible combinations including a parameter from each category, defining an identifier tag for uniquely identifying each generated combination, defining a table tag for representing an associated data of each identifier tag, and saving all tags to an Extensive Markup Language file.

The present invention further provides another method that includes the steps of defining a dimension tag for uniquely identifying each category from the usage data, defining a dimension value tag for uniquely identifying each parameter associated with each dimension tag, and generating a combination for each dimension value tag of a selected dimension tag with each dimension value from other dimension tags once the dimension tag along with the dimension value tag has been created for all categories found in the usage data, defining an identifier tag for uniquely identifying each generated combination, defining a table tag for representing an associated data of each identifier tag, and saving all tags to an Extensive Markup Language file.

The present invention also provides a system that includes an identifier tag for uniquely identifying each generated combination and a table tag for representing an associated data of each identifier tag.

### DESCRIPTION OF THE DRAWINGS

FIG. 1 is an architectural diagram of an implementation using the present invention;

FIG. 2 is a flow chart illustrating the preferred functionality of a method of the present invention;

FIG. 3 is a flow chart illustrating a continuation of the method shown in FIG. 2;

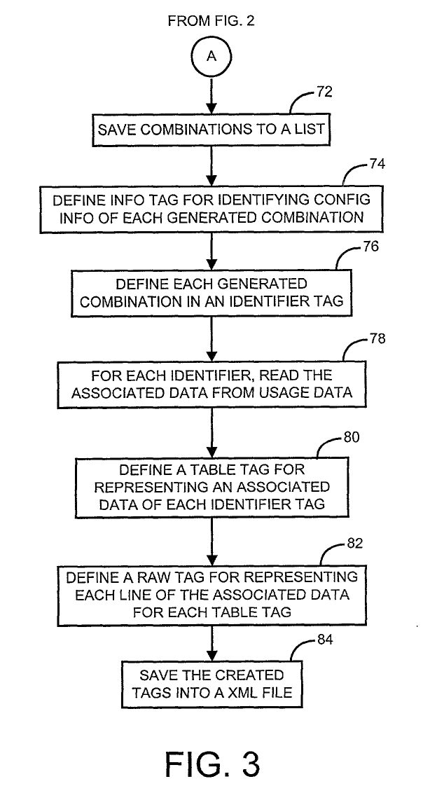

FIG. 4 is an exemplary page displayed on the client using the data archived within a predetermined time interval; and,

FIG. 5 is exemplary page of the Extensive Markup Language file.

### GLOSSARY OF TERMS AND ACRONYMS

The following terms and acronyms are used throughout the detailed description:

Archiver. A computer for archiving data collected by the data collector of an Internet Usage Manager system within a predetermined time interval.

Archive. A single file containing one or more separate files plus information into a format, such as XML or Binary, that allows them to be extracted by a suitable program.

Binary data. A file format for digital data encoded as a sequence of bits but not consisting of a sequence of printable characters (text). The term is often used for executable machine code.

Common Object Request Broker Architecture (“CORBA”). An Object Management Group (“OMG”) specification which provides the standard interface definition between OMG-compliant objects.

Data Collector. A module in the Internet Manger Usage system that continuously collect usage data of the server.

Extensible Markup Language (“XML”). An initiative from the W3C defining an “extremely simple” dialect of SGML suitable for use on the World-Wide Web.

Hyperlink. A navigational link from one document to another, from one portion (or component) of a document to another, or to a Web resource, such as a Java applet. Typically, a hyperlink is displayed as a highlighted word or phrase that can be selected by clicking on it using a mouse to jump to the associated document or document portion or to retrieve a particular resource.

HTML (HyperText Markup Language). A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from a Web server to a browser, the codes are interpreted by the browser and used to display the document. Additionally, in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4).

Hyper Text Transport Protocol (“HTTP”). The standard World Wide Web client-server protocol used for the exchange of information (such as HTML documents, and client requests for such documents) between a browser and a Web server. HTTP includes a number of different types of requests, which can be sent from the client to the server to request different types of server actions. For example, a “GET” request, which has the format GET <URL>, causes the server to return the document or file located at the specified URL.

Internet. A collection of interconnected or disconnected networks (public and/or private) that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols).

Internet Usage Manager (“IUM”). A computer implemented system for managing usage data of the server.

Object Management Group (“OMG”). A consortium aimed at setting standards in object-oriented programming.

Object-Oriented Programming. The use of a class of programming languages and techniques based on the concept of an “object” which is a data structure (abstract data type) encapsulated with a set of routines that operates on the data. Operations on the data can only be performed via the routine sets. These routine sets are common to all objects that are instances of a particular “class”. As a result, the interface to objects is well defined, and allows the code implementing the routine sets to be changed so long as the interface remains the same.

Standard Generalized Markup Language (“SGML”). A generic markup language for representing documents. SGML is an International Standard that describes the relationship between a document's content and its structure. SGML allows document-based information to be shared and re-used across applications and computer platforms in an open, vendor-neutral format.

URL (Uniform Resource Locator). A unique address which fully specifies the location of a file or other resource on the Internet or a network. The general format of a URL is protocol://machine address:port/path/filename.

Usage Data. Data collected by the IUM relating, among other things, to information on users, sessions and usage.

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

### DETAILED DESCRIPTION

Broadly stated, the present invention is directed to an improved method and system for converting usage data into XML. The method and system provide a way to convert usage data collected by a data collector of an IUM to an XML format, which can be used in a web context. Because the Internet provides a more flexible and universal platform, the usage data should be in Standard Generalized Markup Language (“SGML”) for use with a web browser. More specifically, the preferred SGML is XML. Since the data collector is set up to collect data continuously, it is difficult to generate SGML files, such as XML, in this continuous setting. Consequently, the usage data requires conversion into XML.

The present invention is directed to a method for converting usage data into Extensive Markup Language such that the usage data includes a plurality of categories having at least one parameter assigned to each category. The method includes the steps of generating all possible combinations including a parameter from each category, defining an identifier tag for uniquely identifying each said generated combination, defining a table tag for representing an associated data of each said identifier tag and saving all tags to an Extensive Markup Language file.

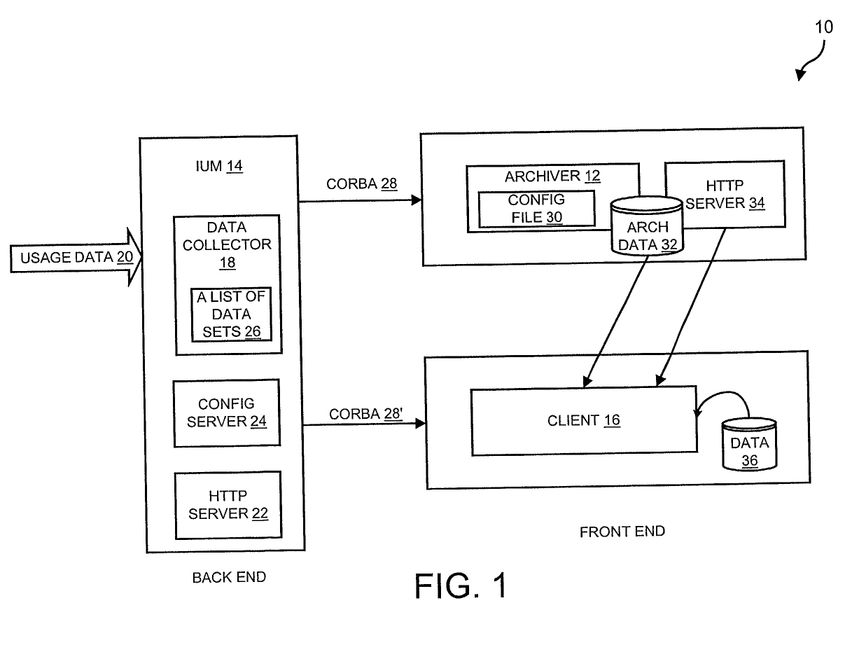

An architectural diagram of an implementation using the present invention with an IUM is shown in FIG. 1, and indicated generally at 10. An archiver 12 is connected between an IUM 14 and a client 16. The IUM 14 is a computer for managing server statistical usage data, and includes a data collector 18 for collecting usage data 20 of users using a HTTP server 22 with specific server configurations 24. It should be noted that the preferred implementation of the present invention is for use with Internet servers (e.g., HTTP servers). However, other servers such as intranet or network servers can be used. These other implementations, with the use of other types of servers, are within the scope of the present invention. A list of a plurality of data sets 26 defined by at least one category is also included with the IUM. Data collected by the data collector is grouped according to each data set in the lists.

The IUM 14 is preferably linked to the archiver 12 and the client 16 via a CORBA connection 28, 28′. Using the settings defined in the configuration file 30, the archiver 12 archives data from the data collector. The archived data 32 is then saved locally. Because the archiver 12 also services the client 16, a HTTP server 34 is preferably used for storing the archived data 32 and servicing the client. In this case, the present invention is preferably used with the archiver 12, wherein the usage data archived is converted into XML. The XML file can then be saved onto the local HTTP server 34. The usage data archived (i.e., archived data) includes a plurality of categories having at least one parameter assigned to each category.

The client 16, on the other hand, is a user interface for displaying the usage data collected by the archiver 12 or the data collector 18 of the IUM 14. If a user desires usage data within a predetermined time interval, the client gathers the needed data from the archive. However, the client 16 can also access the data collector 18. In fact, the client can access data 36 saved locally on the client.

Although it is shown that the archiver 12, the IUM 14 and the client 16 are located on different computers, they can be combined together in any number of computers depending on the preferred implementation. In fact, as is known by those of ordinary skill in the art, the network topology of the present invention can be implemented in various ways. For example, rather than using the archiver 12, the present invention can also be implemented with the IUM 14, specifically the data collector 18 of the IUM. However, various alternative implementations are understood to be within the scope of the present invention.

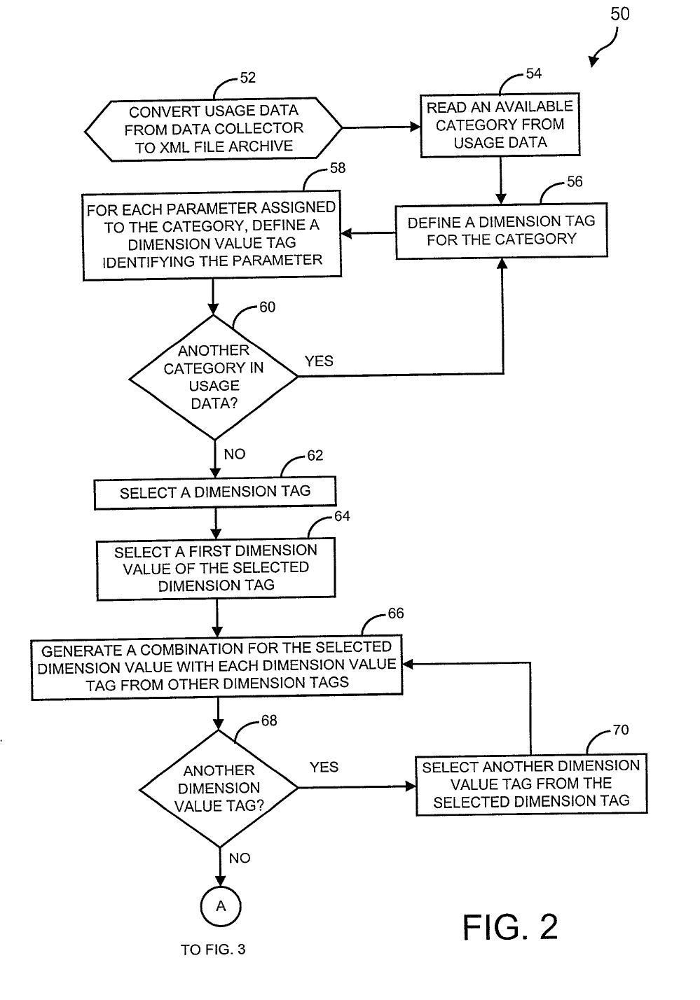

Turning to an important aspect of the preferred embodiment of the present invention, a flow chart of the preferred functionality of a configuration method is shown in FIG. 2, and indicated generally at 50. The present method is initiated by a request to convert the usage data to an XML file (Block 52). An available category is first read from the usage data (Block 54), and a dimension tag will be defined for that read category (Block 56). There may be one or more parameters assigned to this category. However, for each parameter assigned to this read category, a dimension value tag is defined for identifying each parameter in the dimension tag (Block 58). After all the parameters have been identified with dimension value tags in the dimension tag of the category, it is next determined whether there is another category in the usage data (Block 60). If so, the process is looped back to make the dimension tag (Block 56) along with its dimension value tags (Block 58) for the parameters of the category.

If, on the other hand, there is no other category in the usage data (Block 60), a dimension tag will be selected (Block 62). In other words, once all the dimension tags and their dimension value tags have been defined for all the categories with their parameters (Block 60), a dimension tag will be selected. In this case, any dimension tag can be selected. For example, a first dimension tag or a random dimension tag can be implemented to be selected. However, only one dimension tag should be selected.

From the selected dimension tag (Block 62), a first dimension value will then be selected (Block 64). With the selected first dimension value tag (Block 64), a combination is generated for each dimension value tag from other dimension tags with the selected dimension value tag (Block 66). The combination is a recursive step that makes all the possible combinations having the selected first dimension value with the dimension value tags from other dimension tags. After all possible combinations are generated for the selected first dimension value tag (Block 66), it is next determined whether there is another dimension value tag in the same dimension tag (Block 68). If another dimension value tag is available from the dimension tag (Block 68), the dimension value tag will be selected (Block 70). The process is looped back to generate all possible combinations for this selected dimension value tag (block 66). The process keeps repeating until all the dimension value tags from the selected dimension tag have been selected to generate the combinations. Once it is determined that another dimension value tag is not available from the dimension tag (block 68), the generated combinations are saved to a list (block 72). Put differently, once all the dimension value tags of a selected dimension tag have been used to generate all possible combinations, the generated combinations are saved to a list.

The manner in which these combinations are generated will be described in connection with the three categories of user service, model type and time interval. The user service includes the parameters email and web, and the model type includes the parameters distribution and profile. Lastly, the time interval includes the parameters of daily and monthly. Of course, there can be other parameters, but these categories with these parameters are shown only to explain how the combinations are generated. The three categories along with their parameters are shown in the following table for clarity:

| User Service | Model Type | Time Interval |
|---|---|---|
| Email | Distribution | Daily |
| Web | Profile | Monthly |

The parameter “email” will be selected under the selected category of “user service” in this example, and all possible combinations include (1) email, distribution, daily; (2) email, distribution, monthly; (3) email, profile, daily; and, (4) email, profile, monthly. A total of four combinations are generated for the parameter “email.” Next, since there is another parameter in the user service category, the process repeats to generate the following combinations for the parameter “web”: (1) web, distribution, daily; (2) web, distribution, monthly; (3) web, profile, daily; and, (4) web, profile, monthly. Because no further combinations can be generated, the process then continues by saving the combinations to a list.

At this point, it is preferred that an information tag is defined identifying the configuration information of each generated combination (block 74). Also, an identifier tag is defined for uniquely identifying each generated combination as well (block 76). From the usage data, there is an associated data for these combinations. The associated data for each identifier (i.e., the combination) is then read from the usage data (block 78). A table tag is then defined to represent the associated data of each of these identifier tags (block 80). The table tag can be configured various ways for representing the associated data. However, in the preferred embodiment, a raw tag is defined to represent each line of the associated data within each table tag (block 82). Finally, all the created tags are saved into an XML file (block 84).

It should be noted that various different names can be use for tags. Since there is no limit on the type of names that can be assigned to the tags, the names of the tags must be included in trying to represent the general concept and syntax of the present invention. However, it is important to note that other names for the given defined tags can be used, and alternative implementations with various names and syntax are within the scope of the present invention.

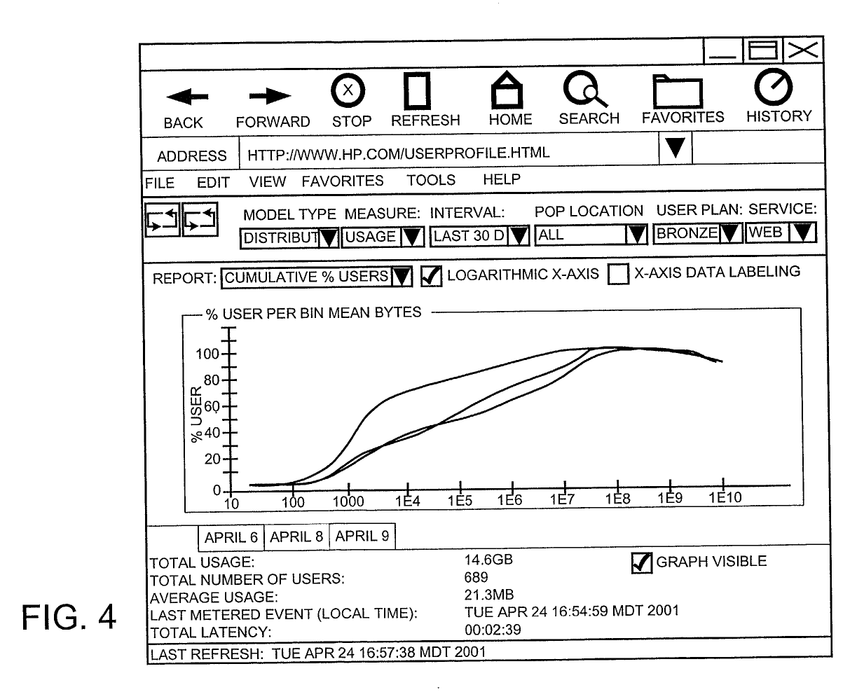

An exemplary page displayed on the client using the converted archived data is shown in FIG. 4. Using the usage data that has been converted to XML, various histograms, graphs and charts can be easily viewed on a browser by users. Near the top of the screen, users can choose specific parameters relating to categories of model type, measure, time interval, geographical location, user plan or user service. In this example, the data set is defined as “distribution” for model type, “usage” for measure, “last 30 days” for time interval, “all” for geographical location, “bronze” for user plan and “web” for user service. A single data set with these specific parameters is defined in the list. For example, if the category time interval is changed to last week with the other categories remaining the same, another data set is defined for these parameters in the XML file. Thus, the XML file has thousands of data sets.

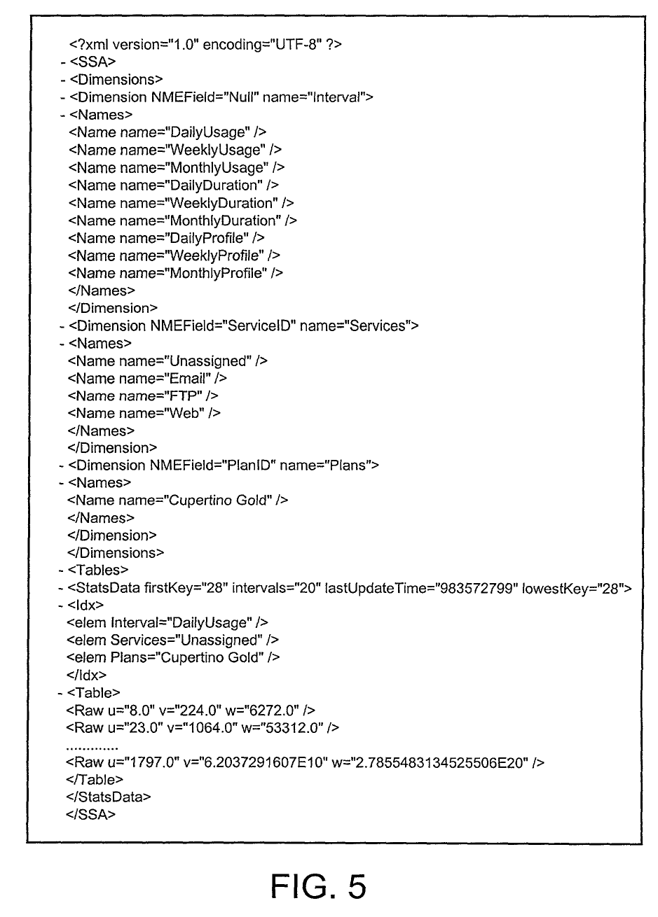

An exemplary page of an XML file is shown in FIG. 5. Shown as an example, three dimension tags (e.g., <Dimension>) are defined for three different categories, specifically a time interval category, a user service category and a user plan category. The end of the dimension is represented by an ending tag (e.g., </Dimension>). As it is known in the art, the starting tag (e.g., <Dimension>) and the ending tag (e.g., </Dimension>) indicate the beginning and the end of that particular tag.

The dimension tag generally includes information relating to the category (e.g., <Dimension NMEField=“Null” name=“ModelTypes”>). Below each dimension tag of the category, a dimension value tag (e.g., <Name name=“DailyUsage”/>) is defined for each parameter. After the dimensions are defined, an identifier tag (e.g., <Idx>) is defined for representing an associated data of each combination. The elements of the combination are represented within the identifier tag (e.g., <elem I=“0”/>). Between the identifier tag and the table tag, an information tag (e.g., <StatsData firstKey=“28” intervals=“20” lastUpdateTime=“983572799” lowestKey=“28”>) is preferably included to identify configuration information of each generated combination.

Once the combination has been properly indicated, each combination is followed by a table tag (e.g., <Table>) for representing an associated data of the identifier tag (i.e., combination). In addition, a raw tag (e.g, <Raw u=“8.0” v=“224.0” w=“6272.0”/>) is defined for each line of the associated data for each said table tag. It should be understood that the syntax of the XML file can be configured in various ways. As a result, FIG. 5 shows a preferred embodiment of the conversion syntax of the XML file. However, other implementations are contemplated and are within the scope of the present invention.

From the foregoing description, it should be understood that an improved method and system for converting usage data into an Extensive Markup Language has been shown and described, which has many desirable attributes and advantages. The method and system provide a way to convert usage data from gathered by an IUM to XML, which can then be easily used in a web based setting on a browser.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method for converting usage data into Extensive Markup Language, wherein the usage data includes a plurality of categories having at least one parameter assigned to each category, said method comprising the steps of:
generating a plurality of possible combinations including a parameter from each category;
defining an identifier tag for uniquely identifying each said generated combination;
defining a table tag for representing an associated data of each said identifier tag; and, saving all tags to an Extensive Markup Language file.

2. The method according to claim 1 wherein said plurality of possible combinations comprising all possible combinations.

3. The method according to claim 1 wherein prior to said step of generating possible combinations further comprising the step of reading an available category from the usage data.

4. The method according to claim 1 wherein said step of generating a plurality of possible combinations further comprising the steps of:
saving said combinations to a list; and,
defining an information tag for identifying configuration information of each generated combination.

5. The method according to claim 1 wherein prior to said step of defining a table tag further comprising the step of reading an associated data from the usage data for each said identifier.

6. The method according to claim 1 wherein said step of defining a table tag further comprising the step of defining a raw tag for representing each line of the associated data for each said table tag.

7. A method for converting usage data into Extensive Markup Language, wherein the usage data includes a plurality of categories having at least one parameter assigned to each category, said method comprising the steps of:
defining a dimension tag for uniquely identifying each category from the usage data;
defining a dimension value tag for uniquely identifying each parameter associated with each said dimension tag;
generating a combination for each dimension value tag of a selected dimension tag with each dimension value from other dimension tags once said dimension tag along with said dimension value tag has been created for all categories found in the usage data;
defining an identifier tag for uniquely identifying each said generated combination;
defining a table tag for representing an associated data of each said identifier tag; and,
saving all tags to an Extensive Markup Language file.

8. The method according to claim 7 wherein prior to said step of selecting a dimension tag further comprising the steps of:
determining whether there is another category in the usage data;
defining a dimension tag for uniquely identifying another category from the usage data if there is another category in the usage data; and,
defining a dimension value tag for uniquely identifying each parameter associated with said dimension tag.

9. The method according to claim 7 wherein prior to said step of generating a combination for each dimension value tag further comprising the steps of:
selecting a dimension tag;
selecting a dimension value tag from said selected dimension tag; and,
generating a combination for said selected dimension value tag with each dimension value tag from other dimension tags.

10. The method according to claim 9 wherein said step of selecting a dimension value tag further comprising the step of selecting a first dimension value of said selected dimension tag.

11. The method according to claim 9 wherein said step of selecting a dimension value tag further comprising the steps:
determining whether there is another dimension value tag in said selected dimension tag; and,
selecting another dimension value tag when there is another dimension value tag.

12. A computer program product comprising a computer usable medium having computer readable program codes embodied in the medium that when executed causes a computer to:
generate all possible combinations including a parameter from each category;
define an identifier tag for uniquely identifying each said generated combination;
define a table tag for representing an associated data of each said identifier tag; and,
save all tags to an Extensive Markup Language file.

13. A computer program product comprising a computer usable medium having computer readable program codes embodied in the medium that when executed causes a computer to:
define a dimension tag for uniquely identifying each category from the usage data;
define a dimension value tag for uniquely identifying each parameter associated with each said dimension tag; and,
generate a combination for each dimension value tag of a selected dimension tag with each dimension value from other dimension tags once said dimension tag along with said dimension value tag has been created for all categories found in the usage data;
define an identifier tag for uniquely identifying each said generated combination;
define a table tag for representing an associated data of each said identifier tag; and,
save all tags to an Extensive Markup Language file.

14. A system for converting usage data into Extensive Markup Language, wherein the usage data includes a plurality of categories having at least one parameter assigned to each category, and all possible combinations including a parameter from each category, comprising:
an identifier tag for uniquely identifying each said generated combination; and,
a table tag for representing an associated data of each said identifier tag.

15. The system as defined in claim 14 further comprises:
a dimension tag for uniquely identifying each category from the usage data; and,
a dimension value tag for uniquely identifying each parameter associated with each said dimension tag.

16. The system as defined in claim 14 further comprises an information tag for identifying configuration information of each generated combination.

17. The system as defined in claim 14 wherein said table tag further comprises a raw tag for representing each line of the associated data for each said table tag.
